(19) United States
(12) Patent Application Publication
(10) Pub. No.: US 2009/0218829 A1
(43) Pub. Date: Sep. 3, 2009

(54) Dumpster lock

(76) Inventors: James R. Stephens, Tifton, GA (US); Dominic Wilkerson, High Springs, FL (US)

Correspondence Address: Flynn Peeler Phillips, LLC, PO Box 7, Albany, GA, 31702, US

(21) Appl. No.: 12/315,059

(22) Filed: Nov. 26, 2008

Related U.S. Application Data
(60) Provisional application No. 61/004,421, filed on Nov. 27, 2007.

(51) Int. Cl. E05C 3/16

(52) U.S. Cl. 292/233

(57) ABSTRACT

The invention is a locking device for a garbage dumpster. The invention includes a vertical channel attached to the front wall of a dumpster. A spring loaded vertical post extends through the vertical channel. A locking mechanism is attached to the spring loaded vertical post and rotatably attached to the top of the vertical channel. When a dumpster is on the ground, the weight of the dumpster against the ground engages the lock on top of the dumpster lid. When the dumpster is lifted from ground, the lock is disengaged from the dumpster lid via a spring.

### RELATED APPLICATIONS

This application claims priority to provisional patent application No. 61/004,421 entitled “Dumpster Lock” filed Nov. 27, 2007 in the name of James Stephens and Dominic Wilkerson.

### FIELD OF THE INVENTION

The present invention relates to a dumpster lock for securing the lid of a garbage dumpster.

### BACKGROUND OF THE INVENTION

Many businesses maintain garbage dumpsters on their premises. The business or a third party may own the dumpster. In any event, the property owner is often responsible for paying to have the dumpster emptied. Unauthorized dumping of refuse in dumpsters increases the frequency with which a dumpster needs to be emptied. To save costs, it is important to business owners to reduce the frequency with which they are required to empty their dumpsters.

Certain dumpster locks appear in the prior art, such as those reflected in U.S. Pat. Nos. 5,201,434; 5,015,021; 5,090,753; and 5662364, the specifications of which are herein incorporated by reference.

What is needed in the art is a dumpster locking device that prevents unauthorized dumping of garbage into a dumpster. What is further needed in the art is a device that is easily unlocked by the property owner, dumpster owner or individual responsible for emptying the dumpster, but difficult for an undesired person to open. What is further needed in the art is a locking device for a garbage dumpster that does not require the garbage truck driver to get out of the truck to unlock the dumpster prior to emptying it. What is further needed in the art is a dumpster lock that attaches to a dumpster at minimal attachment points and does not extend beneath the dumpster.

### SUMMARY OF THE INVENTION

The present invention is a locking device for a garbage dumpster, wherein such garbage dumpster is comprised of two side walls with lift sleeves by which a garbage truck can lift the dumpster off of the ground and empty the dumpster. The garbage dumpster is further comprised of a front wall, a back wall, a bottom surface, and a top surface comprised of a hinged top designed to swing open when the dumpster is lifted and rotated in a direction wherein the front wall begins to face the surface on which the dumpster is sitting.

The device of the present invention includes two vertical tubes for attaching near the top and bottom of a front wall of a dumpster, a vertical post extending through the first and second tubes, a locking mechanism attached to the vertical post between the first and second tubes and to the vertical tube near the top of the front wall of the dumpster. The locking mechanism is comprised of two opposing arms rotatably attached to the vertical post between the two vertical tubes. The two opposing arms extend angled upward. Two opposing angled members extend from the top ends of the opposing angled arms and connect to a horizontal tube which in turn is connected to the vertical tube which is attached near the top of the front wall of a dumpster. A horizontal arm extends through the horizontal tube and extends outward beyond the width of the vertical post. Two opposing L-shaped rods extend between the ends of the horizontal arm and a horizontal lock which extends beyond the length of the horizontal arm. Two opposing extension springs are attached to opposing sides of the vertical post on one end and the second vertical tube on the other end. A node extends outward from the vertical post.

### BRIEF DESCRIPTION OF THE DRAWINGS

FIG. 1 is a front view of the dumpster lock wherein the extension springs are not extended thereby placing the lock in the unlocked position.

FIG. 2 is a side view of the dumpster lock wherein the extension springs are not extended thereby placing the lock in the unlocked position.

FIG. 3 is a side view of the dumpster lock wherein the extension springs are extended thereby placing the lock in the locked position.

FIG. 4 is a front view of the dumpster lock as attached to the front wall of a dumpster wherein the extension springs are extended thereby placing the lock in the locked position.

FIG. 5 is a front angled view of the dumpster lock wherein the vertical post extends through a sleeve connectable to the front wall of a garbage dumpster.

FIG. 6 is a rear view of the dumpster lock wherein the vertical post extends through a sleeve connectable to the front wall of a garbage dumpster.

### DETAILED DESCRIPTION OF THE INVENTION

The present invention is a locking device for a garbage dumpster. Referring now to the several figures wherein like numerals refer to like features across the several figures, one embodiment of the device of the present invention includes two vertical tubes (10a and 10b) for attaching near the top (20) and bottom (30) of front wall (300) of a dumpster (40). The two vertical tubes each contain a flat plate (150a and 150b) which attaches to the flat front wall (300) of a garbage dumpster (40). The plates may be attached by any means that securely attaches the plate and vertical tubes (10a and 10b) to the front wall (300) of the dumpster (40). Such attachment means include without limitation welding or bolting. The vertical tubes are attached to the front wall (300) of a dumpster such that the bottom of the vertical post (50) extends approximately 5-20 inches beyond the bottom of the front wall (300) of the dumpster (40) when the dumpster is lifted off the ground and the extension springs (130a and 130b) are in the non-extended position.

The locking device further comprises a vertical post (50) extending through the first (10a) and second (10b) tubes. In one embodiment of the present invention the vertical post contains a foot (160) for coming in contact with the surface upon which the dumpster sits (i.e., the ground). In one embodiment of the invention, the top of the vertical post (50) includes a cap (170). The circumference of the vertical post is such that it can slide through the vertical tubes (10a and 10b).

The device of the present invention further comprises a locking mechanism (60) attached to the vertical post (50) between the first (10a) and second (10b) vertical tubes and to the vertical tube (10a) near the top of the dumpster. The locking mechanism is comprised of two opposing arms (70a and 70b) rotatably attached to the vertical post (50) between the two vertical tubes (10a and 10b). In one embodiment of the invention the opposing arms (70a and 70b) are attached to the vertical post by a horizontal member (180). The horizontal member (180) may traverse through openings in the opposing arms and vertical post. In one embodiment of the invention, the horizontal member (180) is a lock that may be removed. Removing the lock allows the locking mechanism to unlock even when the extension springs (130a and 130b) are extended. This is beneficial to an authorized dumpster user that needs to gain access to a dumpster without lifting the dumpster off the ground.

The two opposing arms (70a and 70b) extend angled upward. Two opposing angled members (80a and 80b) extend from the top ends of the opposing angled arms (70a and 70b). The two opposing angled members are connected in a manner that allows them to rotate relative to the opposing angled arms (70a and 70b). The two opposing angled members (80a and 80b) are statically connected to a horizontal arm (100) which slides through a horizontal tube (90) connected to the first vertical tube (10a). A horizontal arm (100) extends through the horizontal tube (90) and extends outward beyond the width of the vertical post (50). In one embodiment of the invention the horizontal arm (100) is between 2 and 5 feet in length. Two opposing L-shaped rods (110a and 110b) extend from the ends of the horizontal arm (100) and attach to a horizontal locking member (120) which extends beyond the length of the horizontal arm (100). In one embodiment of the present invention the horizontal locking member is between 3 and 7 feet in length.

Two opposing extension springs (130a and 130b) are attached to opposing sides of the vertical post (50) on one end of the springs and the lower vertical tube (10b) on the other end of the springs (130a and 130b). A node (140) extends outward from the vertical post (50) preventing the lower vertical tube (10b) from extending upward beyond the node (140).

The locking device of the present invention is attached to front wall (300) of a dumpster at the plates (150a and 150b) of the vertical tubes (10a and 10b). The device is attached such that the extension springs (130a and 130b) are extended when the dumpster is in contact with the ground. In other words, the device of the present invention is attached to the dumpster such that the vertical post extends downward beyond the bottom of the front wall (300) of the dumpster when the dumpster is off the ground. In that position, the springs are not extended. The weight of the dumpster on the ground forces vertical post (50) upward through the vertical tubes (10a and 10b). The upward movement of the vertical post (50) causes the two opposing angled arms (70a and 70b) to move upward thereby causing the horizontal arm (100) to rotate towards the dumpster such that one surface of the L-shaped rods (110a and 110b) and the locking member (120) come in contact with the lid of a garbage dumpster. The weight of the dumpster extends the extension springs such that the locking member (120) and L-shaped rods cannot be pulled off of the lid of the garbage dumpster without significant force. Therefore, the extension springs must be of strength sufficient to prevent the L-shaped rods (110a and 110b) and locking member (120) from being pulled away from the lid of the garbage dumpster without significant force.

When the dumpster is lifted off of the ground for dumping into a garbage truck, the extensions prings recoil thereby pulling the vertical post (50) in a downward direction causing the opposing angled arms (70a and 70b) to also move in a generally downward direction which in turn causes the horizontal arm (100) to rotate away from the dumpster causing the L-shaped rods (110a and 110b) and locking member (120) to pull away from contact with the lid of the garbage dumpster thereby allowing the lid of the dumpster to swing open. When the dumpster is placed back on the ground, the vertical post comes back in contact with the ground and is forced in an upward direction by the weight of the dumpster thereby extending the springs (130a and 130b) further causing the horizontal arm (100) to rotate towards the dumpster thereby bringing the L-shaped rods (110a and 110b) and locking member (120) back in contact with the lid of the dumpster locking the lid down.

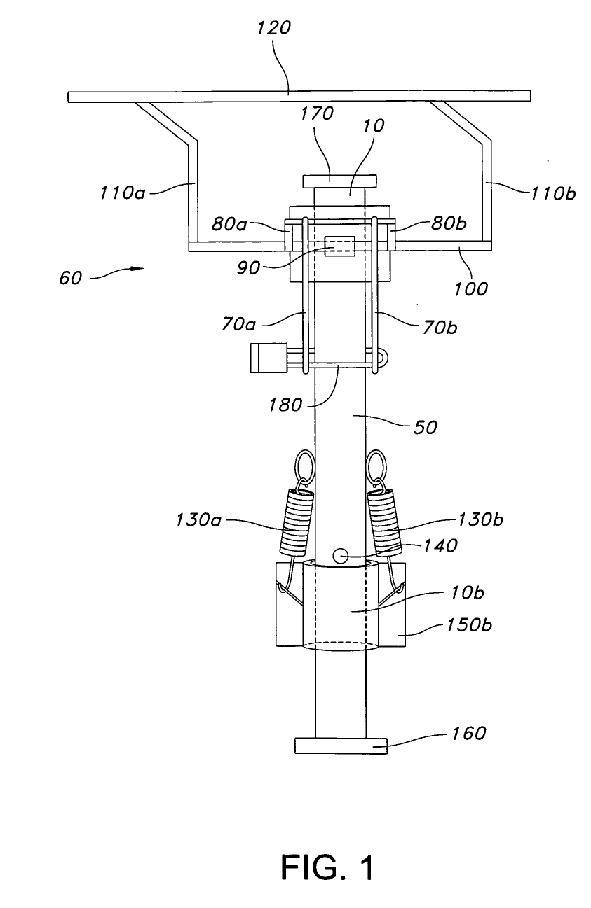

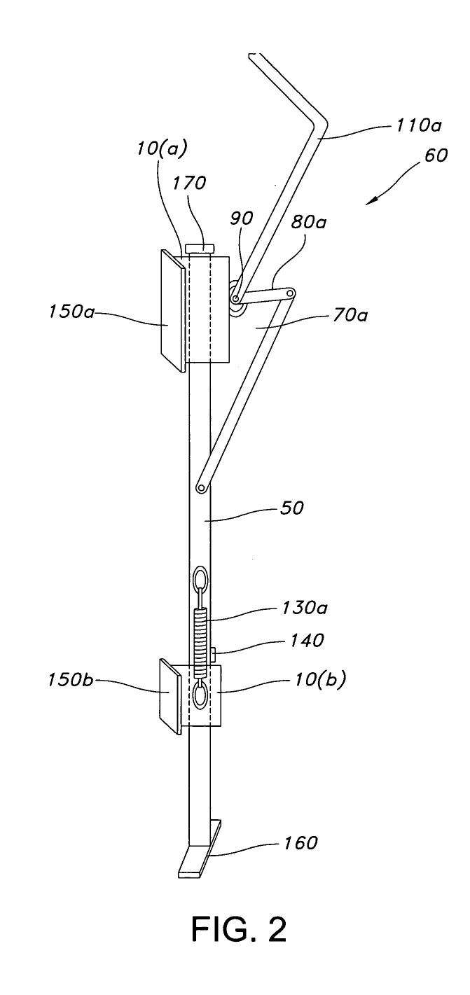

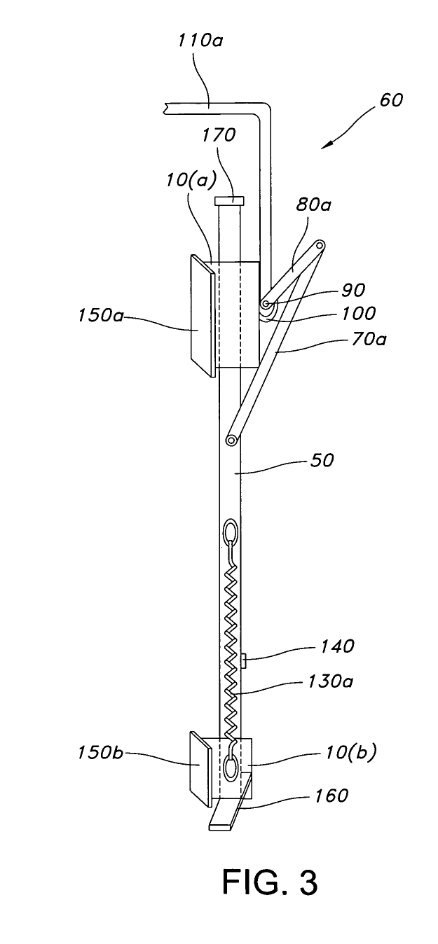

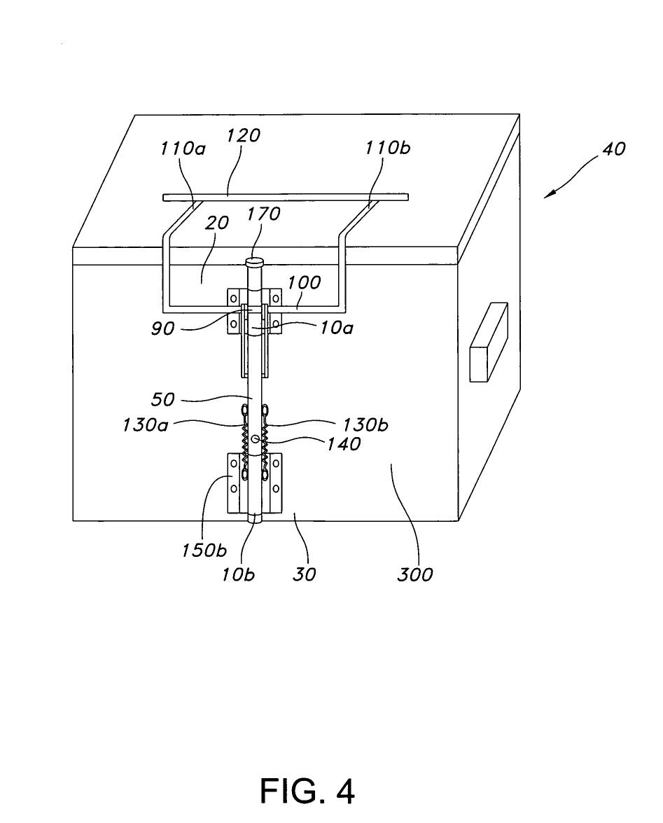

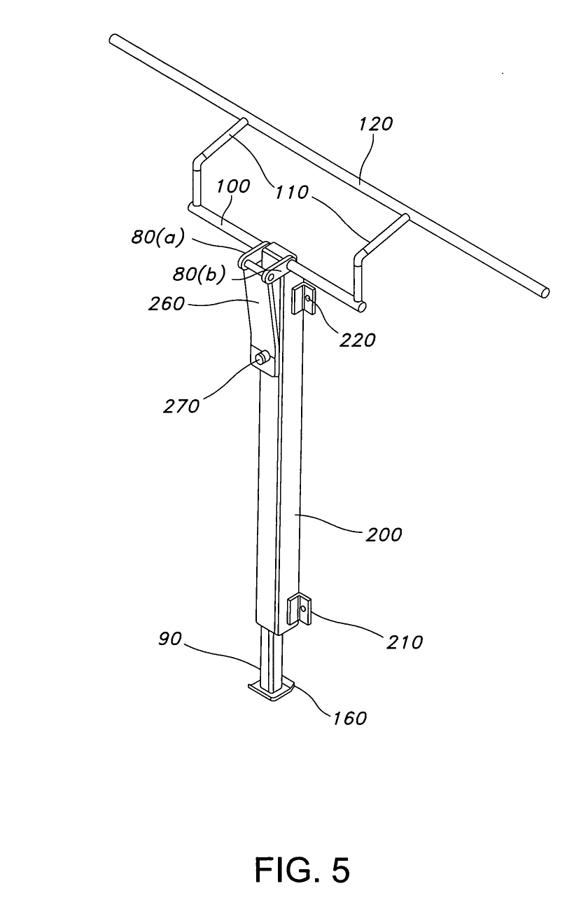

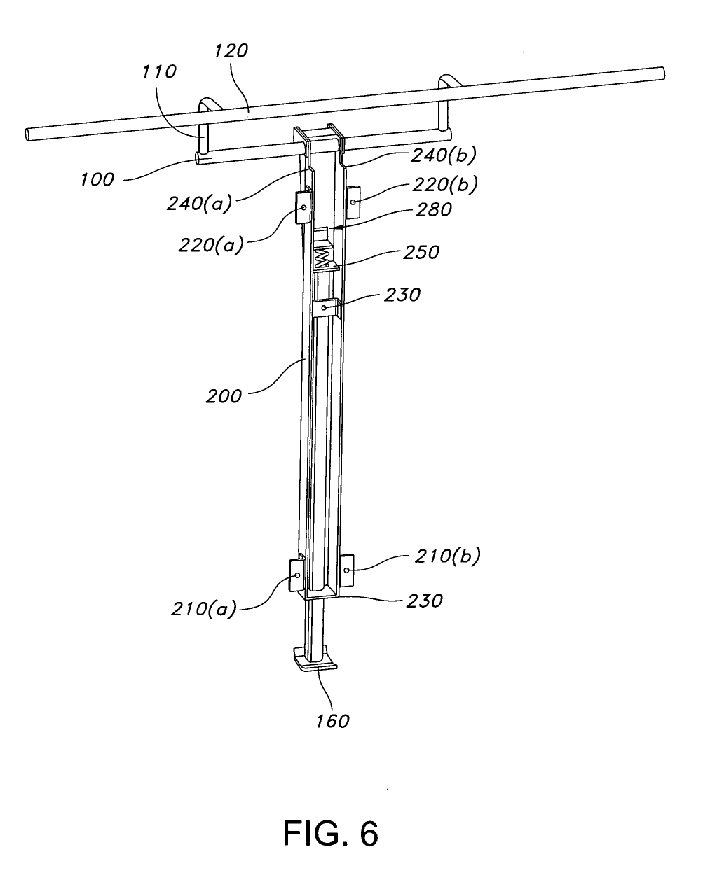

In another embodiment of the present invention (as reflected in FIGS. 5 and 6) the vertical post (50) extends through a frame channel (200) as opposed to or in addition to vertical tubes. The frame channel (200) may be 3-sided or 4-sided. If 3-sided, the open side generally faces the front wall of the dumpster. The frame channel (200) is attachable to a garbage dumpster. The frame channel (200) may be attached to the front wall of a garbage dumpster at certain mount points such as those reflected at (210) and (220). The frame channel (200) may include guide brackets (230) to guide the vertical post (50) as it moves through the frame channel (200). The frame channel (200) may also include L notches (240a and 240b) at the top of the frame channel (200). The horizontal surface of the L notches (240a and 240b) fits beneath a horizontal extending lip (not shown) sometimes present along the top of common garbage dumpsters. In the embodiment reflected in FIGS. 5 and 6, a compression spring (250) may replace or be used in conjunction with the extension springs (130a and 130b) shown in FIGS. 1-4. It is not significant in the present invention whether extension or compression springs are utilized in the various embodiments or the location of such springs so long as a spring functions to release the locking mechanism when the dumpster is lifted off of the ground.

In another embodiment of the present invention a single arm (260) may attach to and extend from vertical post (90) through a vertical slot in the frame channel to angled arms (80a and 80b) which in turn are attached to horizontal arm (100). In this embodiment, the single arm may replace or be in addition to the two opposing arms 70a and 70b. In this embodiment, the single arm (260) may be “unlocked” from the vertical post (90) at a point (270) so that a dumpster owner may unlock the dumpster lid without lifting the dumpster. In this embodiment, the slot in the frame channel is sufficiently elongated so as to allow the post to slide upward enough to engage the lock over the dumpster lid and slide downward enough to disengage the lock mechanism. In another embodiment of the invention (as reflected in FIG. 6) a compression spring (250) is attached to the top of the vertical post (90) and the frame channel (200) at a spring support assembly (280). The compression spring may replace or be in addition to the extension spring (130a,b).

In the embodiment of the present invention reflected in FIGS. 5 and 6, the following is an example of the materials for making this embodiment:

### Example 1

| | | |
|---|---|---|
| Per Device | Name | Description |

Lock Bar Assembly

| | | |
|---|---|---|
| 1 | Cross Tube (120) | ¾″ schedule 40 pipe 60″ long |
| 2 | Cross Arms (110) | ¾″ hot roll 12″ long -bent 90′ |
| 1 | Cross Pivot Tube (100) | 1″ hot roll 24″ long |
| | Fixed Parts | |

Channel Assembly

| | | |
|---|---|---|
| 1 | Frame Channel (200) | 11 ga. plate 46″ long, 9″ wide |
| | | bent 3″ × 3″ × 3″ |
| 4 | Mount Angle (210, 220) | 1½″ angle 3″ long with ¼″ hole |
| 1 | Top Cap Plate | 1½″ × 3″ long × 11 ga. |
| 1 | Bottom Post Guide (230) | 3″ × 3″ × 11 ga. with 1¾ × 1¾ notch |
| | welded to channel | |
| 1 | Spring Fixed Stop | 1½ × 1½ × 3/16 angle |
| 1 | Spring Rod | ½ hot roll 8″ long |
| 1 | Compression Spring (250) | 60 lbs per inch @ 4″ long (LC 105M10S @ |
| | | Lee Spring Co. for $2.64 per spring) |

Post Assembly

| | | |
|---|---|---|
| 1 | Post (50). | 1½ × 1½ × 11 ga. sq. tubing |
| | | 36″ long |
| 1 | Post Foot (160) | 3″ × 3″ × 11 ga. plate |
| 1 | Post Guide Bracket (230) | 3 × 1 angle |
| 1 | Post Top Angle | 1½ × 1½ × 3/16 angle w/⅝ hole |
| | | and a notch for padlock tab |
| 1 | Padlock Tab | 1 × 1½ × ¼ flatbar w/⅜ hole |

Latch Assembly

| | | |
|---|---|---|
| 1 | Latch Bar (260) | 2 × ⅜ flatbar 13½″ long w/1¼ × ⅜ |
| | | notch for padlock tab |
| 2 | Pivot Link (80a, b) | ¼ × 1½ flatbar 4″ long w/1″ hole & 1½ |
| | | hole on each end |
| 1 | Latch Pivot | ½″ ID pipe 3¼″ long welded to latch bar |
| 1 | Latch Bar Bolt | ½″ bolt 4½″ long with nut, spot welded |

Further variations of the present invention will occur to those skilled in the art, and the claims listed below are not intended to limit the scope of this invention.

We claim:

1. A dumpster lock comprising:
a first vertical tube attachable to the front wall of a dumpster;
a second vertical tube attachable to the front wall of a dumpster;
a vertical post slideable through the first and second vertical tubes;
a extension spring connected to the vertical post and a first vertical tube said spring extended when the vertical post slides in an upward direction with respect to the vertical tube;
a lock member comprising:
a first arm movably attached to the vertical post;
a second arm movably attached to the vertical post opposite the first arm;
a first angled member moveable attached to the end of the first arm opposite from the end of the first arm attached to the vertical post;
a second angled member moveably attached to the end of the second arm opposite from the end of the second arm attached to the vertical post;
a horizontal arm connected to the ends of the first and second angled members opposite the first and second arms;
a horizontal tube attached to the first vertical tube and through which the horizontal arm extends;
first and second L-shaped rods attached to opposing ends of the horizontal arm;
a horizontal locking member connecting the first and second L-shaped rods, said horizontal locking member engaged across the top of a dumpster lid when said vertical post slides upward with respect to the vertical tubes and disengaged when said vertical post slides downward with respect to the vertical tubes.

2. The dumpster lock of claim 1 wherein the first vertical tube is further comprised of a plate that is statically attached to the top half of the front wall of a dumpster and wherein the second vertical tube is further comprised of a plate that is statically attached to the bottom half of the front wall of a dumpster.

3. The dumpster lock of claim 2 wherein the vertical post comprises a node extending outward from the vertical post and located above the point at which the vertical post extends through the second vertical tube.

4. A dumpster lock comprising:
a frame channel attachable to the front wall of a dumpster;
a vertical post slideable through the frame channel;
a compression spring connected to the vertical post and frame channel, said spring compressed when the vertical post slides in an upward direction with respect to the frame channel;
a lock member comprising:
an arm rotatably attached to the vertical post through a vertical slot in the frame channel;
a first angled member rotatably attached to the end of the arm opposite the end of the arm attached to the vertical post;
a second opposing angled member rotatably attached to the end of the arm opposite from the end of the arm attached to the vertical post;
a horizontal arm connected to the ends of the first and second angled members opposite the arm;
first and second L-shaped rods attached to opposing ends of the horizontal arm;
a horizontal locking member connected to the L-shaped rods, said horizontal locking member engaged across the top of a dumpster lid when said vertical post slides upward with respect to the frame channel and disengaged when said vertical post slides downward with respect to the frame channel.

5. The dumpster lock of claim 4 wherein the frame channel is further comprised of a first mount plate that is statically attached to the top half of the front wall of a dumpster and a second mount plate that is statically attached to the bottom half of the front wall of a dumpster.

6. The dumpster lock of claim 5 wherein the frame channel further comprises a guide bracket.

7. The dumpster lock of claim 5 wherein the frame channel further comprises first and second L notches.

8. The dumpster lock of claim 4 wherein the arm is unlockable from the vertical post such that the horizontal locking mechanism may be discharged from contact with the top of a dumpster lid without the vertical post sliding downward with respect to the frame channel.

9. The dumpster lock of claim 5 wherein the spring is connected to the top of the vertical post and to a spring support assembly attached to the frame channel.
